(19) United States
(12) Patent Application Publication
(10) Pub. No.: US 2015/0193771 A1
(43) Pub. Date: Jul. 9, 2015

(54) Method and System for parallelizing payment operations

(71) Applicant: Ruslan Pisarenko, Vantaa (FI)

(72) Inventor: Ruslan Pisarenko, Vantaa (FI)

(21) Appl. No.: 14/147,499

(22) Filed: Jan. 4, 2014

(51) Int. Cl. G06Q 20/40; G06Q 20/20

(52) U.S. Cl. CPC G06Q 20/4014; G06Q 20/208

(57) ABSTRACT

The present invention is a system and method of performing operations related to payment process such as performing parties' identification, transaction authorization and other in parallel to trade and other non-payment processes. This allows to significantly reduce and in some embodiments even eliminate time spent on processing payments. In some embodiments pattern recognition technologies allow to significantly automate process of obtaining user information, needed for transaction formation, while in other embodiments principles of continuous processing of transactions allow to eliminate times spent on waiting for transaction authorization.

### CROSS REFERENCE TO RELATED APPLICATIONS

This application claims the benefit of Provisional Patent Application Ser. No.. 61/748,770, filed on Jan. 4, 2013 by the present inventor, which is incorporated by reference.

### BACKGROUND OF THE INVENTION-FIELD

The present invention relates to financial transaction systems, and more particularly to use of pattern recognition in such systems.

### BACKGROUND

Non-cash payments continue to grow worldwide. The benefits of such form of payment, in comparison to cash payments are numerous. For banks the non-cash payment is a tool for better utilization of funds. For bank's customers, both businesses and private persons, non-cash transactions provide the benefit of performing trade without physically possessing cash. The ability to initiate transfer of funds remotely, results for such customers in reduction of risks associated with handling of cash, such as loss or theft.

The core idea of non-cash payments is the ability to transfer information about funds, instead of transferring funds themselves. In particular, transaction information such as transaction amount, account and identity of the user is of interest for parties engaged in trade. There are generally two ways to transfer such and other accompanying information: electronic and non-electronic. Non-electronic means of transferring transaction related information generally include written records of transactions, with paper checks being the most widespread form of such means. Check transfers are considered to have higher risks and lesser convenience, compared to electronic transactions and the share of this form of transaction is decreasing worldwide.

Electronic transactions generally involve means to transfer data electronically between point of trade occurrence and a financial institution. Typically, transfer of transaction information happens over a network. Majority of modern types of electronic payments utilize computer networks to exchange data. The simplest form of electronic payment is the electronic check, which is simply a digital form of check. The main difference is that such check is sent for clearing through network. This form of payment, though having benefits for merchants in terms of processing fees in comparison with other electronic payments, which will be discussed later, is cumbersome for payer. To perform such transaction, payer has to either manually write a check, which is then digitalized using OCR (Optical Character Recognition) apparatus or to manually fill in the digital form, which includes account number and other information.

On example of electronic checks, it can be seen that at the core of electronic transaction technologies is the problem of transferring information supplementary to the amount of trade itself, for example, identity of the user and the account information. Such information can either be transferred using a token or using tokenless method.

Various forms of tokens have been developed, to facilitate the process of feeding the user and account related information into the transaction system through a specialized Point of Sale apparatus, which is part of such transaction system. For instance, development of magnetic stripe cards, in 1950s led to ability to use single card, instead of multiple paper checks to perform a plurality of transactions. Despite significant downside of such method of payments, in particular high vulnerability to fraud, use of this type of financial transaction dedicated token became and remained the most popular method of electronic payment. In fact this method is not fully electronic, as customers are required to sign printed checks as a confirmation of transaction. After magnetic card is read by the reader through swiping or manual input in some cases, information from card, combined with trade related data is transferred through network to the financial institution which holds the account the card is referencing. Financial institution is either authorizes or rejects the transaction, and sends reply to the POS. After that, the check is printed to be signed by customer, and then processed by payee.

The entire process of using magnetic stripe card for payment, in typical situation, takes 15 to 20 seconds in terms of time spent by POS operator on servicing each transaction. On average, about 50 billion card-initiated transactions are performed in the US each year, thus this particular business operation is widespread throughout economy. Any optimization of such operation results not just in significant savings for merchants in terms of transaction servicing expenses, but increases productivity of economy as a whole.

Generally, from the merchant's point of view, the only benefit of using electronic means of payment is the reduction of expenses associated with handling of payments. While the use of electronic payments reduces the labor spent on servicing each transaction in comparison to handling cash, the reduction by modern means of electronic payments are very limited. On the other hand, the transaction fees are significant, averaging in about 1.5-2% of purchase amount. In fact, some studies show that in some cases transaction fees can be higher than merchant's transactional benefit and even initial margin obtained in identical cash payment, thus making such trade unprofitable. On the other hand, the expenses that providers of card payment services face, in terms of issuing and servicing the cards, providing networks for secure data communication and establishing merchant accounts while handling associated risks, generally justify the current rates.

While the situation has been apparent for significant period of time, no solution which would significantly increase the efficiency of electronic payments appeared. The further development of tokens proceeded in two main directions: addressing the problem of fraud and token aggregation through virtualization. Development of smart-cards, which incorporate chips, allowed to add extra tools into payment process, such as encryption of information and tokenless methods of identification, such as PIN codes and biometrics, which will be discussed later. The process of using smart cards is slower than use of magnetic stripe cards, as smartcards need to be inserted into reader device, and after that additional information such as PIN code is inputted. Transaction information is then sent to financial institution for authorization, and only after the authorization or rejection of the transaction is received by the POS, the customer can take smart-card out of the reader. Paper receipt is printed as a confirmation of the operation. Generally, smart-card based payments take 20-25% more time than magnetic stripe payments, in particular due to larger amount of data that is being sent and processed over the network and the need for customer to input PIN codes. Nevertheless, smart cards are the second most popular electronic non-cash payment technology after magnetic stripe cards.

Further development of tokens includes RF-cards, also so-called contactless cards that use Radio Frequency (RF) to transmit the data. This allows to slightly increase the convenience for customer as instead of inserting card into device, the card is simply tapped against the surface of the reader. The downside of this technology is the compromised security, as the content of the card is more easily obtainable by the third parties through use of RF equipment.

The total number of issued payment cards of various types in the United States has reached 1.6 billion, which means more than 5 cards per capita. In other developed countries figures of card market penetration are similar. Such large total amount of cards held by customers causes significant upkeeps in terms of servicing them: renewing expired cards, replacing lost or damaged cards, customer service. Regular production and distribution of such large amount of tokens consumes noticeable amount of resources, including plastics, metals and energy.

The large per capita penetration of cards, leads to situation when their convenience for customer is significantly undermined, as customer is required to carry large number of tokens to initiate transactions of various types. Recently several solutions appeared that solve the problem of large number of tokens through virtualization of such tokens, in particular, mobile device based payments and some forms of tokenless transactions. None of such solutions have reached significant adoption in retail payments. The reasons for this vary, but mainly include lack of benefits for merchants and not sufficient improvement of convenience for customer to justify the change.

Mobile devices or portable computers can be used to emulate tokens. Being a token itself, mobile device has certain difference compared to typical cards. As a re-programmable apparatus, it provides extra opportunities for various software applications to be installed and run, while does require specific servicing by customer such as charging, purchase of data plans and performance of software updates to maintain device security. Another significant difference from transaction-dedicated tokens is that mobile device can be affected by malicious software, such as viruses or key loggers.

The development generally went into direction of communicating token and other related information through various communication means inbuilt in such devices. In particular two approaches currently dominate this area: use of wireless communication and screen data representation for transfer of information. Wireless technologies used for payments, can be generally subdivided into two further lines of development: Near Field Communication (NFC) based mobile wallets and Over The Air (OTA) payments.

NFC based mobile wallets are in their functionality similar to RF-cards, thus need to be tapped or brought very close to reader. They do have extra functionality in terms of ability to pick a certain card for payment through launching and operating a dedicated pre-installed software application. This method is generally slower than the use of banking cards, as users need to perform card selections, inputting PIN-codes on mobile devices and often inputting passwords to unlock their device prior to that. In addition, significant amount of data is transferred over low-latency mobile data connections. Thus, this method was already rejected by major US and other retailers.

OTA transactions are similar to internet payments in terms of no physical connection between POS and the device at the location of trade is required. This technology is different from other token based technologies, as it simply represents a list of customers who have indicated through certain pre-installed application that they plan to visit merchant location. Location information obtained by the device can be used to indicate to merchant that customer is physically present in certain area. This technology is generally very limited in its possible applications, particularly due to high fraud vulnerability which is result of problematic token possession verification, higher complexity in transaction processing by merchants and limited scalability.

Use of portable device screen for representation of various machine readable patterns is the only form of mobile payments that reached certain limited adoption, in particular due to ability of this technology to integrate with existing infrastructure through use of barcodes. Generally, this technology is similar to NFC-applications, with the main difference that user presents mobile device with barcode displayed on the screen, and cashier reads this barcode with POS's barcode reader. This technology generally does not enhance the speed of transaction handling and is subject of inherent disadvantages of usage of mobile device such as need of maintenance and low-latency of connection.

Overall, the main trend in respect to token-based transaction systems is the increase of token complexity and cost, yet no significant progress in terms of optimization of transaction operation performance. And as a result of lack of any new paradigm-changing innovations, the nearly 60-year old and least secure technology of magnetic stripe cards still dominates the electronic token-based payments, accounting for example, for nearly 70% of all such payments in US.

Tokenless transaction systems grant users the ability to perform transaction without physical possession of any man made device or object. Pure tokenless systems have virtually no market penetration, though some tokenless methods are used to verify the origins of certain tokens. Generally there are two distinct groups of tokenless systems: code based systems and biocharacteric based systems.

The simplest yet, more hypothetical then practical example of tokenless transaction system is an electronic check, in a specific case when user fills in the form by remembering a group of alphanumeric sequences, such as his account number, check number and other related information. The similar effect would be achieved if user would remember information printed on the banking card, such as card number, expiration date and security code. As the examples above show, at the core of such code or sequence based systems is the principle of customer remembering certain identifiers by heart, and being able to present those in order to perform transaction. A more convenient form of tokenless system would be system where user can present one or plurality of codes, such as PIN-codes, social security codes or phone numbers, which would be easier to remember then the account related information. An obvious downside of such method is high vulnerability to fraud. For example, stolen credit card numbers and codes account for significant amount of fraud related to card transactions. Further development of code-based transaction technology includes development of transaction specific PINs, such as variable PINs that change over time or in other pattern, in a way predictable only to user. The obvious problem of code-based transaction systems is that in order to increase security, the complexity of code must increase, yet sufficient increase in code complexity makes the system practically unusable by a majority of population.

Biometric transaction systems allow customers to perform financial transactions based on identification of their biocharacteristics. Generally, biometric systems can be divided into systems dedicated to recognize either physical or behavioral traits. Physical traits can include, for example fingerprint, hand geometry, hand veins, finger veins, iris, retina, face, face geometry, face thermograph, ears, teeth, DNA or any other parts of human body. Behavioral characteristics include, for example voice, gait, signature, keystrokes, odor or any other patterns derived from human behavior or nature. Potentially, tokenless biometric based transaction systems can provide highest possible level of convenience for customers, as customer would be capable to perform transactions without possession of any token and no requirements to remember complicated access codes. Also, biometric systems can potentially be the most secure systems, as not the possession of token, but the identity of the payer is identified, which is significant reduction of possibility of fraud.

Despite the potential, during last 10 years, there were several unsuccessful attempts to introduce biometric transaction systems, in particular fingerprint based systems in the US. The reasons for failure of such systems include the increase in time required for transaction servicing by 25-35% in comparison with magnetic stripe cards due to several extra seconds required to perform biometric identification and ethical concerns related to technology. Ethical concerns presented a large challenge in terms of estimation of the amount of users which would adopt such method of payment, as studies show that only about 60-70% of customers support the idea of using biometrics for identity verification and fraud prevention. For many merchants this number was not sufficient to justify significant expenses on biometric infrastructure, and due to lack of any other significant benefits such systems were not widely adopted.

Overall, tokenless technologies are used only as supplementary identification means for verification of tokens. It is likely that code-based solutions will remain in this role, while in respect to biometrics there is a need to build a system that will unleash significant potential of this technology in terms of customer's convenience, yet to provide sufficient benefits for merchants.

Up to this point, all major payment or transaction initiation technologies were discussed. Internet payments were not covered as this technology has little relevance to the embodiments of the present invention. It shall also be noted, that nearly all transaction technologies start their operations after the end of trade has been reached—thus, after the final amount traded between payee and payer has been clarified. The only exception to this use case is pre-authorization that can be performed through certain tokens, but such operation is just a different form of authorization, when money is not withdrawn within short time but reserved, and is generally not a method of increasing of transaction convenience and efficiency but a way to delay settlement and/or obtain collateral against expected amount of trade.

From the discussion above which outlines various technologies and reasons for their successes or failures, it is clear that generally there are three main dimensions which define the popularity of such technologies: convenience for customer, effectiveness for merchant and fraud prevention, which is particularly important to underlying financial institutions that generally are liable for risks. It is also clear that there was lack of any significant advances in said dimensions. Only one technology, magnetic stripe cards, provided significant benefit in terms of convenience over paper checks and as prove of that gained largest market share. Another notable example is the smart-cards with PINs, which provided slight benefits in terms of fraud prevention over magnetic cards and gained significant market share. Yet, there was absolutely no significant advances which can be attributed to transaction systems in terms of increase of effectiveness. This lead to dramatic situation, when transaction handling fees push merchants to courtrooms to protect their right to make profit, while the transaction service providers are unable to lower the fees due to significant fraud within system, which by some estimates accounts to 2% of entire turnover of the payment service providers annually.

Thus, from the current discussion, it can be appreciated that in the area of transaction systems there is a need for significant leap in terms of efficiency. It is clear, that the amount of labor and resources spent by economy on servicing 50 billion transactions in U.S. alone is tremendous, and there have been no advances in this area for significant amount of time.

It is also clear, that convenience of the payment process for customers has to be significantly increased. New system should be easy to operate, reliable and should provide access to plurality of accounts that user holds. Such system should not burden the user with unnecessary maintenance procedures related to specific equipment.

It is also clear, that the security of transaction systems should be increased, so it would allow service providers to lower their fees on transactions. It is also obvious, that only significant increase of security will lead to widely adopted system.

It is also clear, that in order to be adopted, new system should address the ethical concerns of the entire population.

Finally, there is a need for a system that will be flexible to accommodate all the types of transactions and account types which currently exist in financial industry.

The objective of the invention is to reduce the amount of time spent on customer checkout by both customer and merchant through reduction of time spent on performance of payment.

### SUMMARY

Certain aspects of embodiments are disclosed herein. It shall be noted that the following description is just a brief summary of some of the features of embodiments, and is not intended to limit any of the embodiments.

At the core of some of embodiments of invention lays the idea of reducing the overall time of the operation by performing parts of said operation concurrently. At the core of some of embodiments lays the idea of performing entire said operation concurrently to related operation.

In the preferred embodiment, transaction system identifies payer before the end of trade. Identification happens remotely, and processing happens as a background process, while payer and payee are performing other activities. This reduces time, spent by both parties on payment. For example, payer can be identified remotely during the same time, when payee is performing other trade related operations, such as but not limited to, trading with another payer, reading product barcodes, performing packing or unpacking, testing, forming palette, making contractual agreements, performing service or any other activity. Payer can be identified, while shopping, coming to the POS, waiting in queue or during performance of any other operation in the area reachable by means of sampling.

System of this embodiment can consist of pattern sampling means, such as sensors capable to obtain various patterns remotely, such as, but not limited to cameras, infrared cameras, ultraviolet cameras and other means for capturing beams of light in various spectrums or sensors to capture radio or audio waves. The pattern sampling means are connected to or are part of processing apparatus, which consists of processor and memory.

Said apparatus can be further equipped with additional input devices such as numpads, keyboards, pointing devices, touch-sensitive devices, gesture obtaining devices, microphones, card-readers and output devices such as screen, speakers, printers, means of projection and connection to financial network. Transactional information from device can be communicated to financial institution for settlement through a wire, such as central bus, serial port or encoded and sent via one or plurality of packets via network, such as Ethernet, internet, wireless network, or through printed records, physical transportation of device to financial institution, physical transportation of device's memory to financial institution or through writing of information on token. The processing device can yet also consist of plurality of processors and plurality of memories which are grouped into devices, connected by various means of connection. Such devices can be located on-site or remotely, can be connected to financial network. Said devices can run separate instances of specialized software on each device or software can be virtualized over the plurality of devices. Plurality of pattern sampling means can be connected to one or plurality of said devices.

The system of preferred embodiment can be connected to POS device. It shall be noted, that throughout discussion, term Point of Sale (POS) is used in its wider sense, as either operated or automated point, at which trade or other financial operation is being performed, including among others, checkouts/cashier desks in stores, hotels, restaurants, amusement parks, Automated Checkout Terminals, ATMs (Automated Teller Machines), Kiosks, counter terminals in financial institutions or any equivalents, mobile checkout terminals and any other location, where initiation of electronic transfer of funds is possible.

System of this embodiment obtains payer information by recognizing various patterns which are introduced in the environment and are reachable by said systems' sampling means. First, sample of pattern is obtained. Then the sample type is identified. Sample is then matched to template stored in memory. In case of successful matching, payer's account information is retrieved from memory.

Patterns obtainable by said system can comprise, but not limited to parts or whole of: human fingerprint, hand geometry, hand veins, finger veins, iris, retina, face, face geometry, face thermograph, ears, teeth; and non-human patterns, including but not limited to, printed patterns, shapes, patterns represented on the screen, patterns of light, including of blinking light, products of manufacture, clothes, glasses, cards, including banking cards, animals, plants and any other items.

System can recognize both individual patterns or a combination of patterns. In a practical example, shown for the purpose of reader's better understanding of this concept, but not in a limiting sense, certain objects worn by payer, can point to a particular account from which funds are to be drawn for coverage of trade, such as for example badge, working uniform or glasses or any other pre-registered pattern. Another particular example relates to use of mobile device screens for representation of patterns. Payer can log-in in a dedicated application in his/her mobile device, which then shows a certain pattern on the screen. Payer can then represent such device to the pattern sampler.

Yet in another example of system use, shown for the purpose of reader's better understanding of this concept, but not in a limiting sense, is when non-human user such as a machine, such as vehicle or robot, which is enabled to perform payment, such as payment for the parking spot, or payment for goods which were collected, by such machine or for any other purpose, performs payment using inbuilt or connected means of pattern representation, such as screen, printed pattern, shape or means of projection of light.

Due to early identification of the payer, such as prior to payer's engagement in trade or during payer's engagement in trade one or plurality of operation can be performed by transaction sides without increase of overall trade and payment time. Additional operations such as selection by payer of account from plurality of accounts associated with said payer's pattern for payment can also be performed prior to the end of trade. A practical example, shown for the purpose of reader's better understanding of this concept, but not in a limiting sense, is a process where payer is identified at the entry to the store or any other location of trade, and then re-identified at the counter. In this case significant amount of processing related to this payer can be performed, without increase of overall time, such as, for example decision on issuance of credit, packaging and delivery at the counter line of pre-ordered goods or any other time consuming operation. As can be seen from example, the earlier the identification of payer happens, the more actions can be performed between identification and end of trade without increase of overall time.

Alternatively, preferred embodiment can be described as a multi-pattern gate, which allows to use the same infrastructure for a wide variety of means of transaction initiations. Such system is also beneficial because it provides alternatives for certain groups of payers who do not use specific remote identification technologies, such as biometric systems for ethical reasons. As the entire pattern recognition process happens prior to the end of the trade, the overall time of trade and payment is decreased.

System of second embodiment allows to perform early identification of the payer through non-intrusive methods of payer's identification. Payer can be identified remotely, without any specific actions from payer except physical presence in a certain area, and all processing related to payer's identification is performed prior to the end of trade or engagement in trade. For example, payer can be identified remotely during the same time, when payee is performing other trade related operations, such as but not limited to, trading with another payer, reading product barcodes, performing packing or unpacking, testing, forming palette, making contractual agreements, performing service or any other activity. Payer can be identified, while shopping, coming to the POS, waiting in queue or during performance of any other operation in the area reachable by means of sampling.

System of this embodiment can consist of non-intrusive biometric sampling means, such as means for remote sampling of payers biocharacteristics, comprising complete or part of payers face image, facial geometry, retinal or iris information, ear shape information or any other similar biometric information, as well as voice, gait, signature, keystrokes, odor or any other patterns derived from human behavior or nature. The non-intrusive biometric sampling means are connected to or are part of processing apparatus, which consists of processor and memory.

Similarly to the preferred embodiment, apparatus of second embodiment can be further equipped with additional input devices such as numpads, keyboards, pointing devices, touch-sensitive devices, gesture obtaining devices, microphones, card-readers and output devices such as screen, speakers, printers, means of projection and connection to financial network. Transactional information from device can be communicated to financial institution for settlement through network connection, printed records, physical transportation of device to financial institution, physical transportation of device's memory to financial institution or through writing of information on token. The processing device can yet also consist of plurality of processors and plurality of memories which are grouped into devices, connected by various means of connection. Such devices can be located on-site or remotely, can be connected to financial network. Said devices can run separate instances of specialized software on each device or software can be virtualized over the plurality of devices. Plurality of pattern sampling means can be connected to one or plurality of said devices.

Software of the system of second embodiment performs both the functions of payer identification and payer tracking, which is a form of additional identifications. Due to early identification of the payer, such as prior to payer's engagement in trade or during payer's engagement in trade a combination of biometric identification methods can be used. This provides for significant increase in transaction security without increase of overall time of trade and payment.

The system of second embodiment would also allow for significant increase in convenience, as system would have highly accurate information about payer's location, including orientation of his head or eye's pupils. Such system can predict which surfaces would be observable by payer, and to bring relevant payer information onto such surfaces by means of output devices, such as screens, light projectors or sound devices. It is important to note that system can recognize a plurality of payers. Through system the amount of trade can be covered by drawing funds from several accounts represented by different payers. A practical example, shown for the purpose of reader's better understanding of this concept, but not in a limiting sense, a group of friends, or family, or co-workers can each pay for a part of a bill, while such payment is performed simultaneously, and does not increase overall time spent by parties on both trade and payment.

The system of third embodiment, is a biometric identification system, which allows to identify payer prior to the end of trade. The performance of operations related to payer identification in parallel with other operations, such as but not limited to those mentioned in preferred and second embodiments. This allows to reduce time spent on both trade and payment. Another benefit comes from elimination of payer's need to use any tokens in order to perform identification, which is a significant increase of convenience. Additional operations such as selection by payer of account from plurality of accounts associated with said payer's biometric sample for payment or entering of PIN number for security purposes can also be performed prior to the end of trade. Overall time of trade and payment is decreased.

The system of third embodiment is similar in its architecture to system of the second embodiment, except for sampling means. Sampling means of system of third embodiment are capable of obtaining payer's various biometric information, such as but not limited to, fingerprint, hand geometry, hand veins, finger veins, iris, retina, face, face geometry, face thermograph, ears imagery, teeth imagery and samples, DNA, voice, gait, signature, keystrokes, odor or any other patterns derived from human behavior or nature. Biometric sampling means are connected to processing device which consists of processor and memory and is running specialized software. First, biometric sample of payer is obtained. Biometric sample is then matched to template stored in memory. In case of successful matching, payer's account information is retrieved from memory.

Alternatively, instead of using biometric sensor for identification of the user, system of third embodiment can employ payee's personnel to perform such identification, by representation of biometric information through means of output and confirmation of identification by means of input. Users, who have pre-enrolled to perform trade through such means as internet or mobile devices can be identified prior to the beginning or end of trade, which allows to decrease waiting times associated with performance of payment. Such use case allows significant reduction of time spent on payment particularly in relation to fifth and sixth embodiments.

In the forth embodiment transaction system obtains customer information prior to the end of trade, by buffering customer's card or other token, such as mobile device information read through appropriate input means. Payer is able to input his information while payee is performing other trade related operations, such as but not limited to trading with another payee, reading product barcodes, performing packing or unpacking, testing, forming palette, making contractual agreements, performing service or any other. The process of payer taking out, reading, and concealing the token does not elongate the entire process of trade and payment. Tokenless methods of identification such as inputting PIN or other code or biometric identification can be also performed prior to end of trade. Once total amount of transaction is identified, transaction is performed. Overall time of trade and payment is decreased.

In the third and forth embodiments, in particular case where two payers are present and when second payer's identification is performed while payee is trading with first payer, it may be useful to either place the reader or scanner in location where second payer can input his information without interacting with or disturbing the first payer. Other possibility is installment of plurality of readers or scanner devices, so several payers can input their information into transaction system in parallel. Also, this would allow payer to input his information at significantly earlier stage, which would allow to perform more operations without increase of overall time, and then to input his information for the second time, to be precisely identified.

Fifth embodiment represents a method of transaction processing that can be applied to the systems described in preferred embodiment and embodiments two, three and four. System of fifth embodiment, generally refers to trade performed at POS. As items are being scanned or services counted, the total amount of trade is increasing. Instead of waiting for the end of trade to be reached, when final amount is known, system authorizes current amount, once it reaches a certain value, called threshold. In such a way, by the time end of trade is reached, most of the value has already been authorized. The last piece of unauthorized value, in case it is lesser then threshold can be authorized after customer leaves the POS. As a collateral to guarantee the successful authorization, even in case of insufficient funds on payer's account, payer deposits a certain amount, which is larger than threshold to a dedicated account, from which system can draw funds without any constraints. Such amount is deposited at a registration stage, prior to start of trade. Said method allows to nearly completely eliminate time dedicated solely to authorization of transaction.

Furthermore, the funds for coverage of trade can be drawn from one account, or from basket of plurality of accounts pre-registered by payer.

In practical situation, which is mentioned for the purpose of reader's better understanding of this concept, but not in anyway limiting current embodiment, about ⅓ of time spent by typical cashier on servicing each customer, is spent on servicing the payment procedure while rest is generally spent on barcode scanning and in some cases bagging of products. By significant reduction of time spent on payment servicing, the productivity of cashier is significantly increased.

Sixth embodiment represents a method similar to fifth embodiment in the main idea of continuous authorization of trade amount prior to the end of trade, with difference in stages of the method. A vault account with payer-deposited funds, accessible to system is maintained. The vault account holds the funds sufficient to cover the purchase that payer typically performs during certain types of trade. At the start of the trade, system checks the available funds on said account, and in case end of trade is reached and the total amount of trade is less than the available funds, system performs the funds transfer. As funds on the vault account serve as collateral, the parties of trade do not need to wait till the end of authorization. In case the amount of trade is larger than the funds available on vault account, an additional standard sum is authorized, with vault account being the destination for funds. Once the end of trade is reached, the funds equivalent to trade amount are transferred from vault account to payee account through means of EFT (electronic funds transfer). If the vault account's balance is less then pre-configured amount, payer's account is automatically charged to refill the vault. Said method allows to significantly reduce overall time of trade and payment.

From the discussion above, it is clear, that the present invention allows to significantly decrease the time spent on trade and payment, by parallelizing payment process with other processes. Early registration of customer information allows system to perform various trade related operations. Due to possibility to perform more operations, security of such system can be increased dramatically. The continuous authorization of trade amounts allows to combine the procedure of payment authorization with other operations performed during the trade, thus practically eliminating the time spent on waiting for payment authorization. Combined with early registration, said principle allows to significantly increase the efficiency of payment processing, which is a widely practiced operation worldwide. Benefit of the present invention to the economy in general, can be estimated through estimation of total amount of time spent by cashiers on transaction servicing. As total amount of transactions worldwide is equivalent to 260 billion, and each transaction servicing lasts generally about 15-20 seconds, a total of about 2 million man-years can be saved annually, a number which is comparable to the amount of work a city the size of Philadelphia is performing on annum.

Further benefits of the present invention will be apparent from the following drawings and detailed description.

### BRIEF DESCRIPTION OF THE DRAWINGS

FIG. 1 shows general overview of the system, particularly the hardware platform.

FIG. 2 shows software architecture of the system comprising two modules: identification and execution.

FIG. 3 and 4 show example algorithms of execution module of operation.

FIG. 5 shows algorithm related to forth embodiment.

FIG. 6 shows algorithm of multi-pattern recognition.

FIG. 7 shows algorithm of mono-pattern recognition.

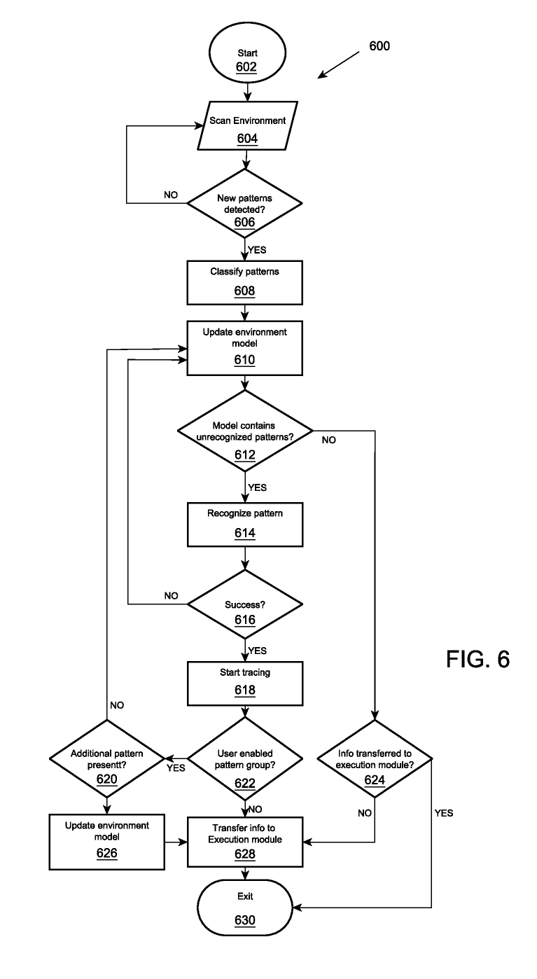

FIG. 8 shows algorithm of use of pre-generated pattern in recognition process for device.

FIG. 9 shows algorithm of pre-generation of pattern for Identification module

FIG. 10 shows algorithm of pattern tracing.

FIG. 11 shows algorithm related to fifth embodiment

FIG. 12 shows algorithm related to sixth embodiment

FIG. 13 shows several types of processes related to prior art and embodiments in terms of duration of such processes.

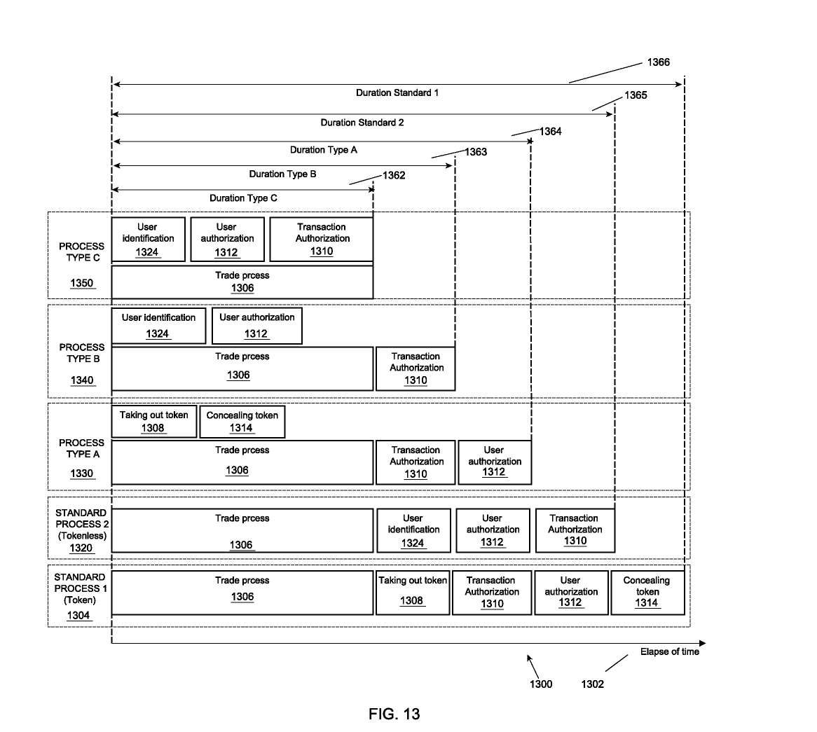

### DETAILED DESCRIPTION OF THE INVENTION

The following detailed description of embodiments of present invention is provided to teach those skilled in the art to construct embodiments of the invention. However, this invention can have many other embodiments, so the scope of it should in no way be limited to the embodiments described below.

The description of the embodiments will take the reader from the description of Hardware platform, to description of Software Platform and then two modules of that platform: Execution module and Identification module will be described. Then Continuous transaction functionality will be described. Finally, in Operational description, parallelizing with related processes and embodiments will be described in comparison with prior art.

### Hardware Platform

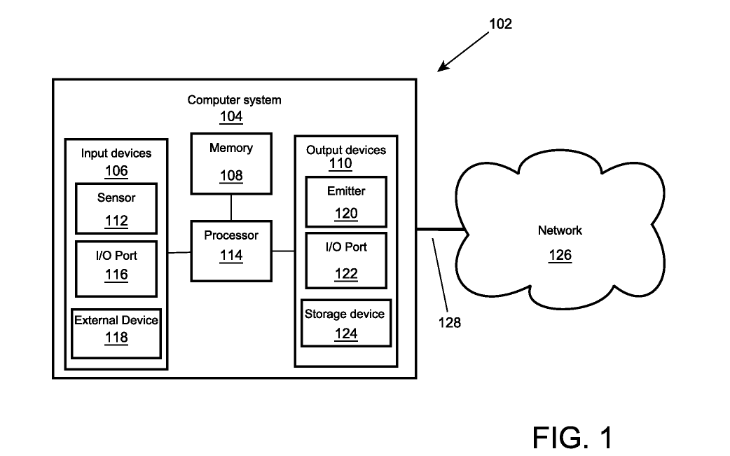

According to FIG. 1, an exemplary embodiment of computer system 102 in accordance with the present invention includes processor 114 and memory 108. Such system should be built to be capable to perform computations, according to best practices known in the art. Processor 114 can be of any type of one or plurality of devices used to perform computations, comprising circuits of various configurations and chips or microprocessors. Memory 108 can be any device, capable to store and retrieve information, in particular, computer readable memory, which comprises electrical connection having one or more wires, portable computer diskette, random access memory (RAM), read-only memory(ROM), an erasable programmable read only memory(EPROM or Flash memory), optical fiber, portable compact disk of any type. It shall here be noted that produces such as paper or shapes can be used to store information, though would require additional input apparatus to enable processor to access such memory. Memory can also hold operating system, which provides upper level applications, such as system modules with access to hardware of system.

Computer system 102 can additionally include one or plurality of Input devices 106. Input devices are used to obtain information external to said computer system. In particular sensor 112 type devices can be used for such purpose. Sensor devices are devices capable of converting information not processable by processor 114 to information processable by said processor. Examples of sensors can include devices capable of detection and conversion of optical, mechanical, electro-magnetic, thermal, chemical or other states or changes in environment external to Computer system 102. For purpose of user better understanding of the embodiments, but not in a limiting sense, sensor 112 can comprise devices capable of obtaining electromagnetic radiation of various wavelength such as visible spectrum cameras/sensors and invisible spectrum cameras/sensors to obtain X-ray, ultraviolet, infrared, microwave and receivers to receive various types of radio waves. It shall be here noted that in relation to present discussion the term camera is used to describe sensor that has certain capabilities of controlling flow and/or focus of incoming particles of matter. Sensor can be configured to receive both direct and reflected: rays, light and waves. Other types of sensors can be used, to obtain other information, such as various buttons, numpads, keyboards, pointing devices, touch-sensitive devices, gesture obtaining devices, microphones. Yet other examples of sensors comprise various token readers, such as card-readers of various models and operational principles.

Input device 106 can also be represented by I/O Port 116. I/O Port is a channel which allows transferring information to and from computer system 102, and can be performed both in hardware or software implementations in various ways, widely known in the field. As an input device, it allows to receive information abstracting away from the source of information.

Yet another type of input devices can be external devices 118. External device is a device that is part of system 102 for a limited amount of time, and has useful functions which it can perform without computer system 102. Not in a limiting sense, such external devices can be various stand alone or networked computers, portable or mobile devices, wearable devices such as medical equipment or any other.

Computer system 102, can also include various output devices 110, that allow to output information to environment external to system 102. Examples of emitter devices can include devices capable of performing optical, mechanical, electro-magnetic, thermal, chemical and other changes in the environment. In a non-limiting sense, emitters comprise such devices as radio wave transmitters, light and other radiation sources and any other capable to communicate information to external environment and to particular elements of such environment, such as for example humans or non-humans, which can be plants, animals or other systems and devices. Further, such devices can comprise screens, speakers, printers, means of projection which can be for example, light emitting diodes or light bulbs or any other. It is important to note, that devices should also be capable to output intelligible information, thus, complex information which can be interpreted by its destination.

I/O Ports 122, are similar in their technology to I/O Ports 116, though their function is to provide a channel to output information from system 102, abstracting away from destination of such information. Storage device 124 comprises any type of memory, such as similar to memory 108. Storage devices can be part of computer system 102 temporarily, and can be used to transfer information to different systems. Additionally, External device 118 can be used as storage device, if its internal composition allows for such arrangement.

Network 126 is a one or plurality of devices of various types and functions, which generate and communicate information between devices within such network. The main function of network is to communicate results of computation of computer system 102 to other devices, so those computations can affect the state of information within network 126. Network 126 can be local, external or inter network, employing technologies well known in the field. Connection 128 to such network can be implemented in variety of ways, comprising port implementation, technologies similar to technologies used in network 126 or technologies other then in network 126. For the purpose of reader's understanding, but not in a limiting way, while network 126 can be using LAN and WAN technologies, connection can be using such technologies as serial ports, implemented using infrared light or radio waves as carriers of information. Other configurations are possible, and depend on convenience of technology for particular user.

Overall, computer device 102 provides all the necessary computational and communicational hardware capabilities for software system described in the further segment of detailed description to perform required operations through various embodiments.

### Software Platform

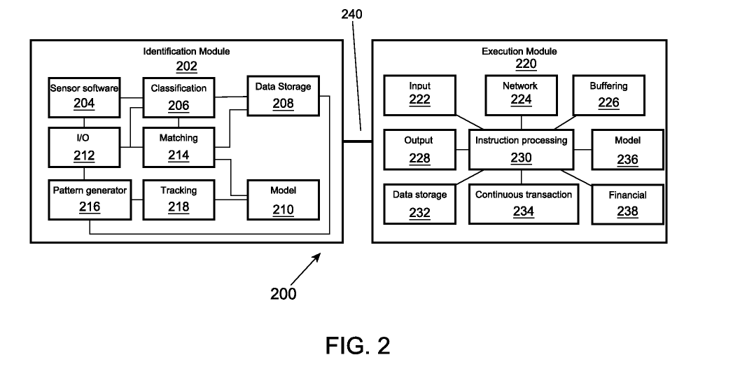

FIG. 2 describes software platform 200, which is a foundation for the functionality of embodiments. Platform consists of two main modules: Identification Module 202 and Execution Module 220. The main function of the platform is provision of all necessary software components and building blocks, such as memory, data and process management to sub-modules 204-238. An important characteristic of platform 200 is its near complete abstraction of architecture from the underlying hardware, so such system can be successfully implemented on top of virtual machine, thus can run or be moved between one or plurality of computer systems 104. This is particularly useful, when there is significant distance between hardware components 106-124, as such location mismatch can be handled in the lower levels of virtual machine without any change to software platform.

Identification module 202 is able to perform identification of parties of transaction. Its main functionality includes obtainment of identification information, and its comparison against stored data. Sensor software 204 allows to obtain and process information from hardware sensors. Sensor software 204 can also perform additional operations, such as extraction, refinement and other operation with raw data, in order to create a template which can then further be matched using Matching sub-module 214. An example of such processing, given for purpose of reader's better understanding, but not in the limiting sense can be image cropping, application of Gaussian functions for image transformation, wavelength modulation and other operations well known in the field. Additionally, data can income through I/O 212 sub-module, which performs input-output operations. In such a case data can be pre-processed or can be transferred to Sensor software 204 sub-module for processing. Matching 214 sub-module compares obtained template with template stored in Data Storage 208 sub-module, which allows to identify record associated with such template. Connection 240 which is an abstract connection between two modules is used to transfer identified record from Identification module 202 to Execution module 220.

In certain embodiments Identification Module 202 is configured to process multiple types of patterns. For such purpose Classification 206 sub-module is used. Classification sub-module generally identifies the type of pattern that needs to be recognized and forwards the template to the correct Matching sub-module 214. Identification of pattern type can be performed through parsing of the data associated with the template or by analysis of template, in case template is a multi-pattern template. Analysis of template can generally include recognition of pattern types by application of rough patterns obtained from Data Storage 208 against the template, with further conversion of multi-pattern template into one or plurality of mono-pattern templates. Such mono-pattern templates, which generally contain patterns of single type are forwarded to appropriate Matching 214 sub-module for matching against templates contained in Data Storage 208 sub-module.

Data Storage 208 can generally be built using wide variety of technologies comprising but not limited to databases, file systems, maps, hierarchies and other. The main considerations depend on types of samples that database handles. Combination approaches can also be used, for example, database holding references to files within file server instead of holding actual data and so on.

Information from Matching 214 sub-module is further transferred to the Model 210 sub-module. The function of Model 210 sub-module is to create a virtual representation of environment within reach of sensor, group of sensors or I/O device. Many instances of Model 210 sub-module can be present, to represent various environments. Model 210 can be built to hold listings or hierarchies or any other collections of traceable objects. Tracking 218 sub-module analyses the model, and indentifies changes within it. Functionality of Tracking 218 sub module will be further discussed in relation to tracing process. Pattern generator 216 sub-module generates patterns which can be transferred to External device 118 for further input, and also transfers such patterns to Data Storage 208 for association with record. Functionality related to Pattern Generator 216 sub-module will be further discussed in relation to Recognition of generated pattern process.

Execution module 220 is able to perform operation associated with user record passed through Connection 240 from Identification module 202. While Identification module 202 is generally limited to processing of patterns and data from sensors, Execution Module 220 not just performs the operations but obtains additional information through Input 222 sub-module. Input 222 obtains all information received by Execution Module 220. In some embodiments, Input 222 obtains from Sensor software 204 information that does not require matching for pattern recognition purposes. As a non-limiting particular example of later statement, information from buttons, numpads, keyboards, pointing devices, touch-sensitive devices, gesture obtaining devices, microphones and various token readers, such as card-readers of various models and operational principles can be used in Input 222. This information can be used as additional information, required or voluntary, for the purposes of operation execution.

Instruction processing 230 is a hub sub-module, connected with all other sub-modules 222-238 of Execution module 220. Instruction processing 230 obtains instructions and information from all other sub-modules 222-238, performs operations and sends processed information to said sub-modules. Information received from and sent to sub-modules includes sub-module identifier and code of instruction which sub-module assigns to Instruction processing 230 to execute. Instruction processing 230 would load instruction from Data storage 232 based on the identifier and code after what it parses and executes instruction for the data that was obtained. Such method of implementation allows to reuse the same modules for large number of operations, by simply updating instructions stored in the database. Alternatively, Instruction processing 230 can hold all the necessary instructions as part of it code. Yet alternatively, Instruction processing 230 can be absent, with all other sub-modules 222-238 being interconnected and each being able to execute instructions held within it, for particular types of data that such sub-module operates.

Output 228 uses various Emitters 120 to introduce information into environment external to the system, particularly outputting information from Execution Module 220. For example, Output 228 would be used for purposes of user interaction, performance of operations, external storage of information and other functions. As a non-limiting example, user interaction can be performed through screens, speakers, printers, means of projection. Performance of operations means not mere interaction, but a more stable change in environment, which can involve, for example control of lights, mechanical, chemical or other equipment, locking and unlocking of safes and other devices. Output 228 performs external storage of information by using Emitters 120 capable to, for example, create compact disks of any type and to communicate with external devices.

Network 224 sub-module is a module that allows to represent a network in abstract way. Underneath it can be a real network or emulation of network. Generally, such module would be able to both receive and send messages to network, performing all the necessary functions involved in networking, which may comprise but not limited to formation of network messages, discovery, addressing, encoding, and other activities typical for network connected devices.

Data Storage 232 allows to store and retrieve various types of data ranging from records to instructions. Data storage 232 can be built using standard methods to store data, comprising but not limited to databases, file systems, maps, hierarchies or other. General consideration is that software technology of 232 should provide for seamless virtualization and scaling. Other sub-modules of execution module 220 can have certain data stored within them. This can be implemented as separate functionality or direct referencing of data storage. In some embodiments, all data within Execution module 220 are stored within Data storage 232.

Buffering 226 is a sub-module that allows buffering and queuing of data, for example in FIFO (first in first out) or FILO (first in last out) manner, or using other comparable methods. Instances of Buffering 226 would represent locations where several inputs were made, but the instruction execution is suspended before additional information is provided through Input 222. Such functionality is at the core of forth embodiment, and will be discussed in relation to such.

Model 236 sub-module allows to represent current state of environment in certain area reachable by system's sensors. It can be built to hold listings or hierarchies or any other collections of objects. It has inbuilt methods to iterate through itself to generate events which can be further processed by other sub-modules of Execution module 220. Model 236 generally allows for complex queuing when several types of payment methods are involved and several types of inputs such as automated and manual are expected to perform or resume operations. For example, if biometric and non-biometric payments are to be performed in unknown order, and several customers have been identified, Model 236 can be checked to see which particular customers have not been yet processed, and additional information request such as manual selection of customer can be prompted through Output 228 and received through Input 222. Model 236 can also substitute Model 210 when Tracking 218 can not perform tracing, for example in case of limited possibility to detect change in environment due to specific choice of sensors. As a simple non-limiting example, single fingerprint scan performed by infrared sensor/camera would be sufficient to further re-identify party of trade by provision of extra description, such as photograph through Output 228, thus no additional sampling and follow up recognition is needed.

Continuous transaction 234 sub-module provides functionality necessary to divide transaction into parts, and can buffer and compare balance information and other related data. Functionality of Continuous transaction 234 will be further discussed in relation to fifth and sixth embodiments.

Execution Module 220, can further include Financial 238 sub-module which provides functionality for transaction message formation, which can otherwise be handled by Data Storage 232 which holds the necessary instructions and Instruction processing 230 which executes such instructions. Financial 238 contains blocks responsible for conversion of information received through Input 222 and complemented by record data obtained from Data Storage 232 into messages processable by financial network. Messages can cover various types of transactions comprising debit and credit (drafting) in terms of type of account that is subject to such transaction. Also messages depend on types of transaction handling methods used, ranging from checking to major banking card processing. Additionally, Financial 238 analyses message responses, and generates appropriate messages for Output 238.

Execution Module 220 is a highly flexible module, capable to perform wide variety of operations connected to inputting and outputting information, storing and retrieving information from database, performing specialized processes such as financial transactions and continuous transactions, modeling and buffering of information. As an example of module operation shown for reader's better understanding, but not in a limiting way, Execution Module 220 would get user information from Input 222, and then would retrieve from Data storage 232 all necessary information concerning the types of operations that module can perform. Part of such information would be forwarded to Financial 238, such as account related information, while part will be sent to Output 228. Depending on the contents of information, for example if additional input is needed, such as input about value of trade, same process can be repeated several times. Then once all information is collected, transaction compiled by Financial 238 will either be stored in Data storage 232 or forwarded by Network 224, depending on the configuration. Alternatively network 224 can be used as additional input and output to gather necessary information within Execution module 220. All communication and execution of operations is performed by Instruction processing 230 module. Additional modules such as Continuous transaction 234, Buffering 226 and Model 236, can also be involved by directing data to them, and then retrieving resulting output from such sub-modules. This example shows, that such architecture is sufficient to support wide variety of functions, which is necessary in order to enable software platform 200 to support many of embodiments.

Overall, software platform 200 which performs both identification and execution functions, provides hardware independent foundation for various embodiments.

### Execution Module Functionality

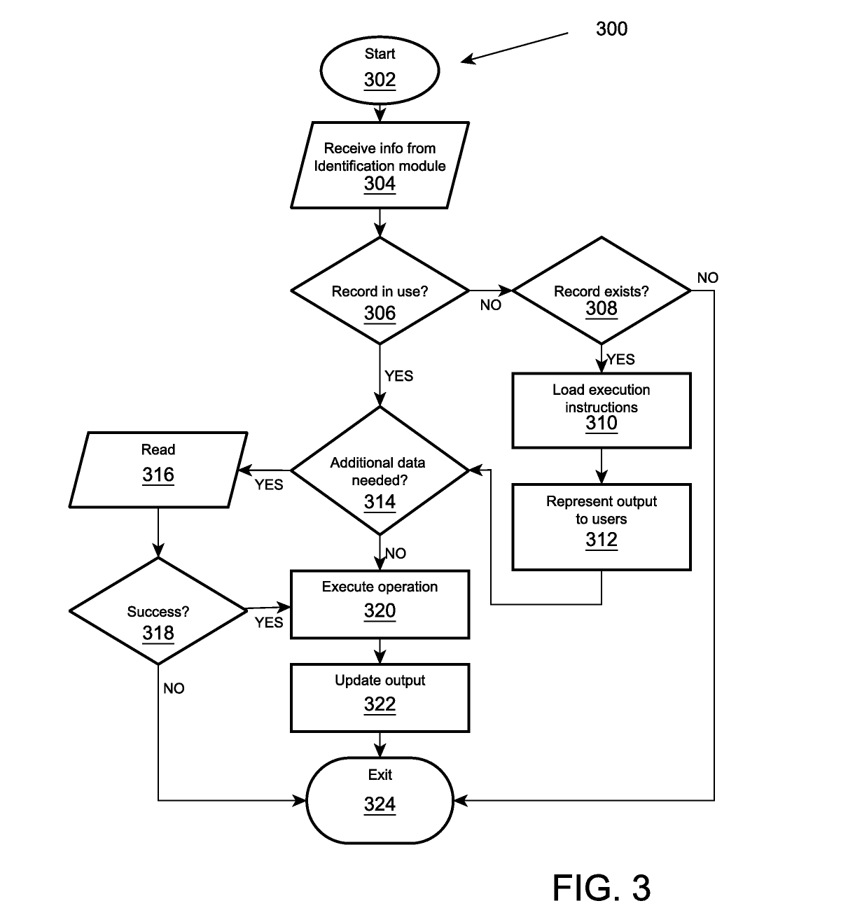

FIG. 3 shows an example algorithm 300 of Execution module operations. While it is clear from above description, that there are number of ways the module can perform operations, the algorithm provides a non-limiting example which allows to abstract away from operations that execution module performs in order to simplify further descriptions of various embodiments.

After Start 302, Execution module performs Receive information from identification module step 304. Information would generally include certain record of user which has been matched by Identification module. For example, it can be certain user number or set of variables that allow to identify similar record in data storage part of Execution module. Execution module then checks if record is already in use 306, which would signal if there was already operations performed with such record as part of the current process. If this record is not currently in use, module checks if such record exists 308. If record does not exist, system would exit 324, and can optionally perform some output operations. In most of the cases, the simple exit would be sufficient in this run, as if Execution module does not hold any information about such record, no operations need to be performed.

In the case record exists, Execution module loads execution instructions 310 and represents output to users. Execution module would then check if additional data is needed in step 314. Alternatively, if module finds record to be in use 306, it can proceed directly to step 314 in order to identify if additional data is needed. As a non-limiting example, Identification module may send information about secondary identification of user associated with record, for example as user moves to the point of sale. In this case, Execution module would already have instructions loaded 310 and would be ready to proceed with step 314 to identify if additional data is needed.

If no additional data is needed, step 320 executes operation, which can be, for example financial transaction and updates output 322 to notify users. Alternatively, if additional data is needed, execution module reads 316 data from input, and in case data was successfully read and verified 318 it proceeds to step 320 to execute operations. After execution of operations 320 and respective output 322, process exits 324.

As a simple example, shown for the purpose of reader's better understanding of how algorithm 300 can be applied for parallelizing of transactions happening prior to the end of trade, FIG. 4 shows a simple algorithm 400. Step 408 is an abstract step representing all operations performed by Identification module which will be described later and operations performed by Execution module which relate to steps 304-318. After that, Execution module can check if End of trade (EOT) 412 event has happened, and if not, it will wait 416, check if Trade was cancelled 414 and if not, then would check for EOT 412 event again. After End of trade 412 has happened, Execution module would Authorize the transaction 418 and then exit 420.

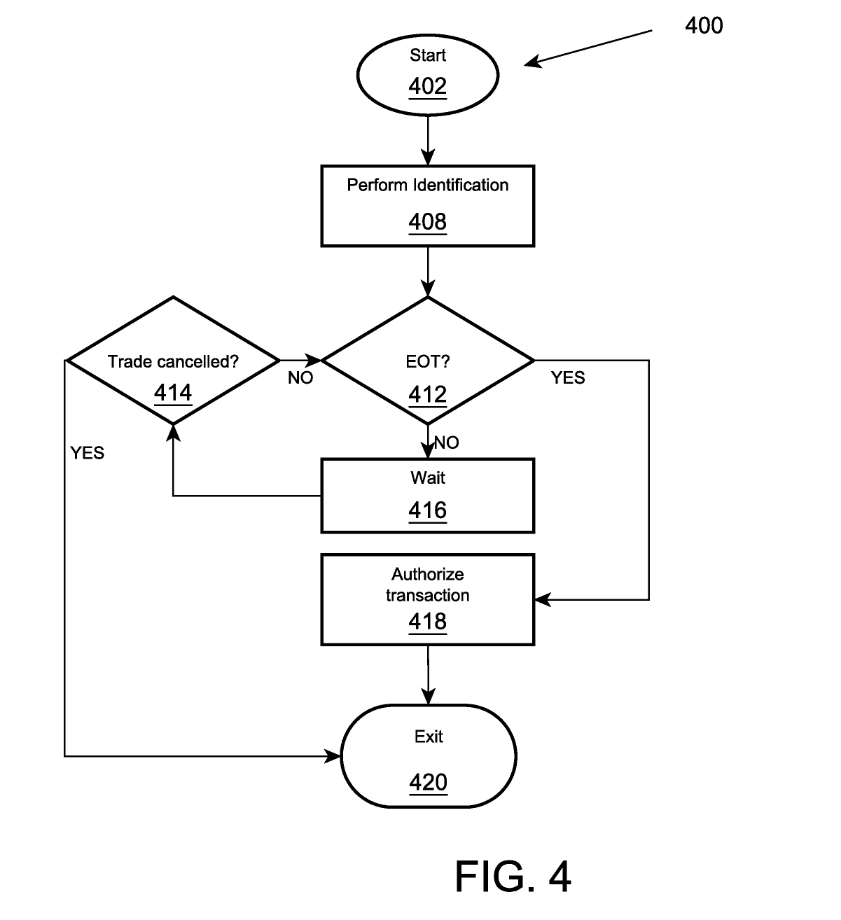

FIG. 5 shows example algorithm 500 of Token information buffering, which relates to forth embodiment. In this embodiment, no pattern recognition needs to be performed, and Identification module is mainly used to read and transfer information obtained from various sensors, which can be card readers using various technologies from magnetic stripe card readers, to smart card readers (which use inbuilt chips) to Radio frequency card readers that are used for obtaining data from so-called contactless cards. It shall also be here noted, that tokens can be of various forms and shapes, ranging from keychains to various tags fixed to or part of closes or produces or even implanted in the body of users. The main distinctive characteristic of this embodiment is that no pattern recognition needs to be performed, and data is simply obtained and parsed.

After start 502, Scan token 504 step is performed. As explained above, Step 504 can be performed by Identification module or alternatively Input sub-module can be advanced to be able to handle raw input from sensors/token-readers. Further, Execution module checks if user identification is possible 506. For example, if user is using PIN-chip card, user PIN-code or biometric can be read straight away by step 508. The benefit of this arrangement is clear, as both token scanning and user identification happens prior to the end of trade, thus can be performed in parallel with other processes. The operational description part will further explain the benefits of such processing.

After checking of user identification possibility 506, Execution module buffers available information in step 510. Module then will keep this information in buffer, and check if End of trade (EOT) event has happened 512. If EOT even hasn't happen, module will wait 516, and check if trade is cancelled 514. If trade has been cancelled module would clear buffer 520 and exit 522.

If End of trade has been reached resulting from check 512, Execution module would Authorize transaction 518 and exit 522. Step 518 can be performed in wide variety of ways, from using specialized networks, to outputting data, to storing data locally. The later is beneficial, if for example, the Execution module itself functions as core banking solution and accounts internal transactions.

Overall, it is clear that Execution module is capable to perform various types of operations, and can play important role in enabling parallelizing of payment operation, as algorithms featuring identification prior to end of trade show. Further, particularly in relation to Continuous transaction operations, it will become apparent how functionality related to Execution module can perform even larger amount of operations prior to the EOT, reducing the overall time spent by both payee and payer on servicing payment.

### Identification Module Functionality

The main function of Identification module is recognition of patterns associated with records. Some embodiments require recognition of patterns of multiple types by same system while other are mono pattern systems. Multi-pattern recognition can be performed in parallel or linear fashion. Parallel multi pattern recognition means that there are several sensors, and each is dedicated to the pattern of certain type. Pattern types can be, for example biometric patterns, thus derived from biological organisms and patterns of various objects, which can be natural objects or produces. Output from sensor of such pattern would be mono-pattern template. By combination of mono-pattern sensors it is, for example, is possible to achieve higher levels of security.

On the other hand, many mono-pattern sensors introduce significant costs and complications to infrastructure. Linear multi-pattern recognition is a method to recognize several different types of patterns present in the same template. By classification of patterns into types and division of multi-pattern template into one or several mono-pattern templates, it is possible to identify stored templates of similar type and match them one by one. An important distinction is between virtually immutable pattern that is recognized, and pattern that is first generated and then recognized.

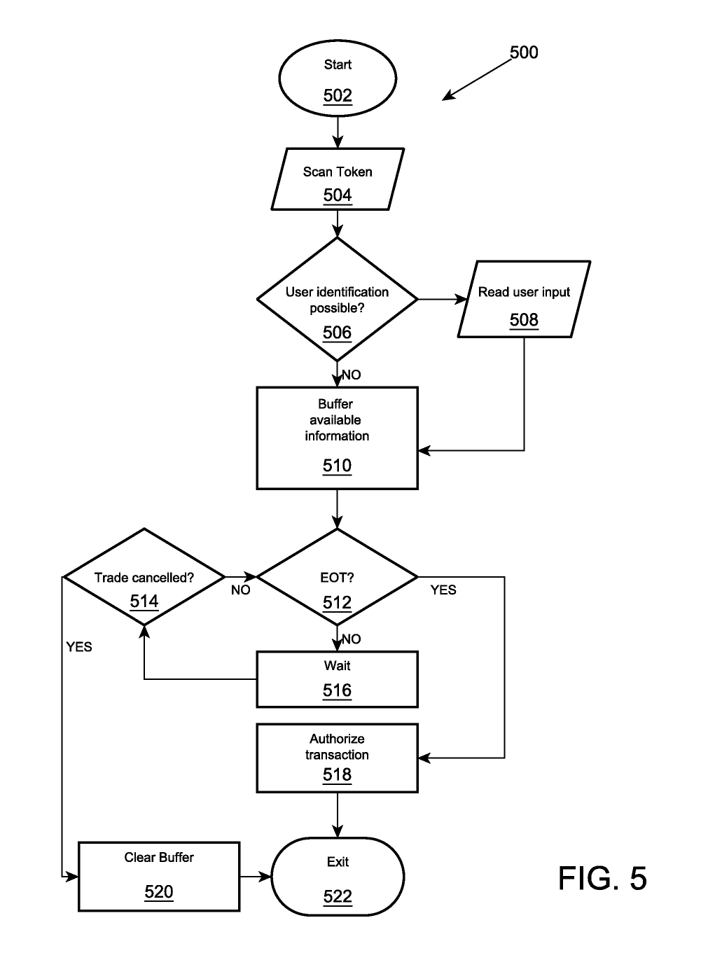

FIG. 6 represents a multi-pattern recognition process 600. After start 602, Identification module scans the environment 604. Scanning can be performed in a recurring manner, so system does not require input from any operators to perform scanning. Alternatively, if high frequency of scanning procedures is not desirable, scanning can be initiated by operator. In its core, scanning is record of change or of environment state by sensor, and further comparison of previous template to new template. Comparison happens in order to identify if template contains any significant changes which can be treated as patterns in step 606. Alternatively, step 606 may perform detection of selected pattern types. Further step 608 classifies newly detected patterns or all patterns present in template, depending on implementation. Classification happens by comparison of rough or simplified pattern templates against newly acquired template. As a non-limiting example, certain stored patterns can be applied to identify if new template contains biological face or hand, or for example a barcode or a certain amplitudes and frequency of sound waves. This would allow to separate part of template containing such possible pattern into a separate template, and label it as a template containing a certain class of pattern. Steps 604-608 can be performed for both parallel and linear multi-pattern recognition, with main difference being in classify patterns 608 step, where instead of analysis of single template, multiple templates are classified and forwarded to update environment model 610.

As a next step, Identification module would update the environment model 610. This is done in order to preserve all potential patterns and to accumulate changes in the model, and to abstract the rest of the process from the physical characteristics of sensors. Step 612 then checks if model has any patterns that are not recognized, and if yes, it creates separate processes to recognize each particular pattern. If model does not contain unrecognized patterns, step 624 is executed to check if information has been transferred to the execution module, and after that either information is transferred 528 or process exits 630.

If model contains unrecognized patterns, Step 614 does the pattern recognition by comparison of template obtained from model with template stored in the data storage. If pattern is not recognized, template in the model is removed or marked blank, depending on the implementation. If pattern is recognized then step 618 starts tracing. Tracing will be described further on as a separate diagram.

Step 622 checks if the record associated with recognized pattern allows to execute special instructions if group of patterns is present. Group of patterns simply means patterns which are associated and are present in environment model within certain period of time. Group of patterns may contain patterns of identical type or of different types. If pattern group option is enabled, then step 620 checks if additional pattern is present by reviewing the model. If patterns are not present it would update the model indicating that newly recognized pattern can be a group pattern, and the process will proceed further up to the point when there are no unrecognized patterns left in the model. Otherwise, if additional pattern is present, model is updated to indicate that patterns are grouped, and information is transferred to execution module in step 628 to execute associated operations and then process exits in step 630.

Step 622 can also identify that record does not allow group of patterns and then information would be transferred straight to execution module in step 628, after which process exits 630.

The process described above is a foundation for the preferred embodiment. It allows multiple patterns to be used to identify various parties of trade, which addresses the downside of biometric transaction systems, in particular limited ethical acceptance of such technology, as was explained in prior-art overview. Additionally, multi-pattern processing allows using groups of patterns to point to a particular set of instructions to be executed in response to detection of such pattern group in the environment, which can significantly simplify the payment process by reduction of need to input additional information. As a non-limiting example, group patterns can point to specific account of user, which is to be used for financial operation. More importantly, multi-pattern recognition can happen prior to the end of trade, which would allow to reduce overall time spent on servicing the payment operation, as will be further explained in the operational description part.

At this point it should be noted, that as preferred (first), second and third embodiments primarily describe functionality performed by Identification module, their functionality in Execution module can be implemented in two alternative ways: in standard way according to FIG. 4 as was described before or through Continuous transaction functionality described in embodiments five and six which will be discussed in the next section.

Second and third embodiments are both based on algorithm show on 700 FIG. 6. Algorithm 700 that allows to detect single pattern in a mono-pattern recognition system. Though, less effective then multi-pattern systems in terms of infrastructure utilization, mono-pattern recognition systems can be a suitable foundation for embodiments in order to reduce time spent on trade.

The algorithm describes operations performed by Identification module. After start 702, it scans the environment 604 by sensors. The most significant difference between second and third embodiments lay in the area of sensors. Third embodiment generally uses sensors which require certain separate actions to be performed by users ranging from physical contact between sensor and pattern to specific set of operations, such as placing patterns in certain areas or representing at certain angles. As a non-limiting example, fingerprint recognition, hand gesture recognition, voice recognition, barcode scanning or other similar operation can be performed to identify party of trade. Such methods are clearly intrusive, and require specific operations such as placing finger onto fingerprint reader's surface in order to perform recognitions. Additionally, sensors of third embodiment allow parties of trade to be identified generally a limited number of times in terms of convenience and efficiency, as each identification requires party to perform a certain action. In order to perform recognition prior to the end of trade either location of sensors has to be adjusted in order to allow several payers to be recognized without undue discomfort, or several sensors should be placed, in order to perform several recognitions of each payer along the path of movement. Alternatively either payee or payer can have elements of control through input and output sub-modules of execution module, in order to perform single recognition, yet prior to the end of trade.

One particular type of recognition, that can be performed as a part of second embodiment is OTA payment by mobile device or internet. As a first step, user pre-enrolls to perform payment in specific location through internet. Then the additional information, such as GPS coordinates are obtained by user's device and are transferred to the merchant or payee. Payee's personnel is then performing identification using their natural senses, generally following the process similar to process 700. In particular, payee's personnel is informed about some characteristics of payer, such as but not limited to appearance, name, code and any other information. As personnel identifies payer 708, information is transferred to Execution module 712 where standard operations can be performed. In case personnel is capable of payer's identification prior to the end of trade, significant amount of operations, such as operations described in embodiments five and six can be performed without increase of overall time of trade and payment processing.

Compared to sensors of third embodiment, sensors of second embodiment generally perform non-intrusive identification. A good example of such sensors can be sensors/cameras capable of recognition of biometric traits comprising but not limited to face, iris, odor as well as various objects and shapes and radio frequency waves. Such sensors allow to perform recognition at significant distance and can be used for several recognitions to be performed without any specific actions by the subject of recognition. Such sensors allow to significantly increase the time period between beginning of recognition and end of trade, that provides for more operations to be performed in between, without any increase of overall time spent on trade and payment by parties of trade.

Step 706 assesses the module's model in order to identify if new patters are introduced in environment. Pattern recognition 708 then matches the template that was obtained from sensor to template that is stored in data storage. In case of successful identification 710 and retrieval of record associated with pattern, information is transferred to execution module 712. If identification was not successful, then process exits 714.

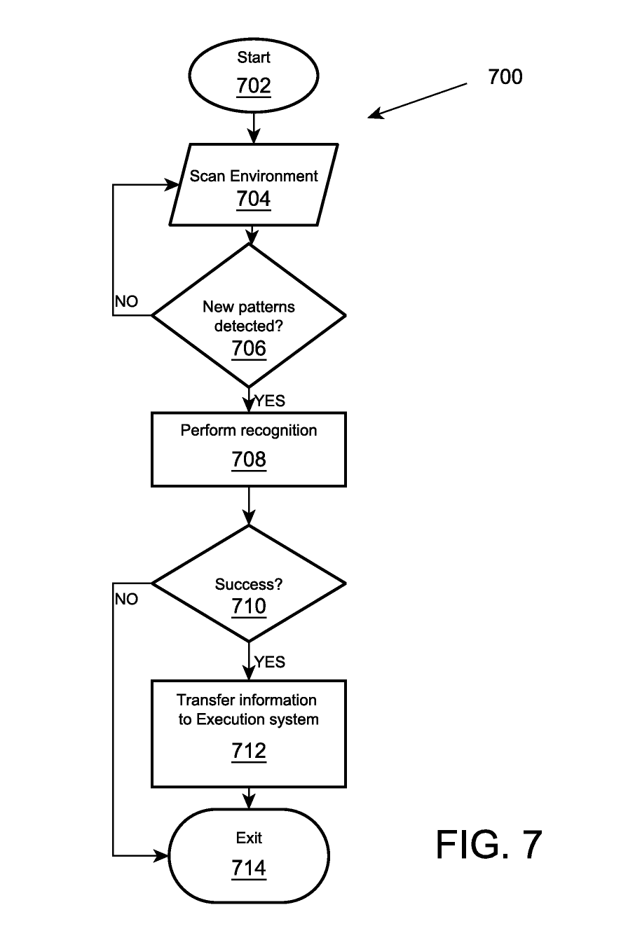

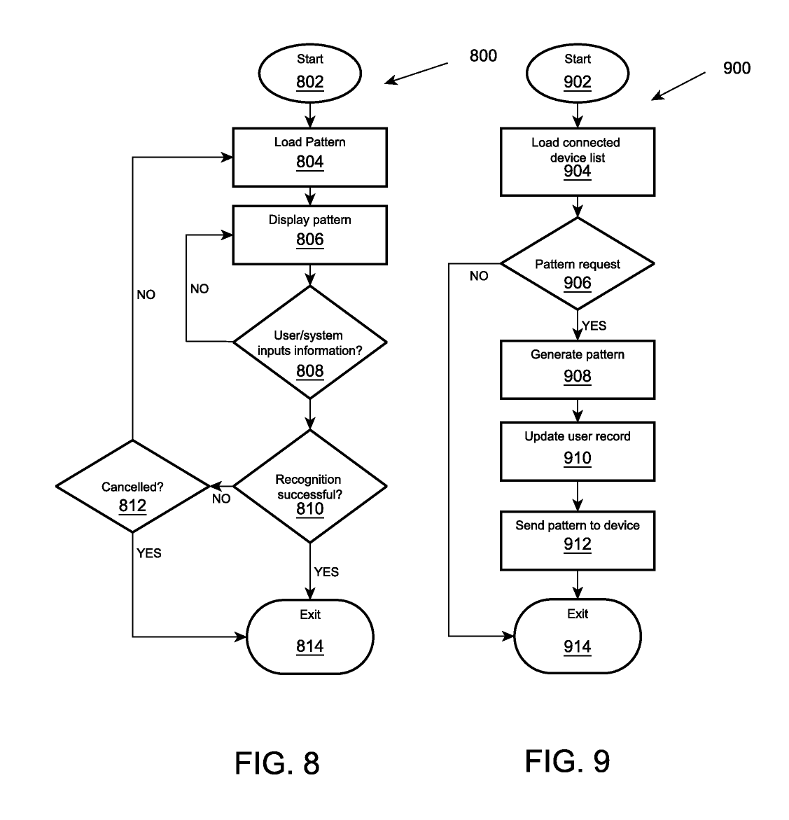

In certain embodiments pattern that Identification module recognizes can also be generated by Identification module. This is done in order to achieve higher level of security in recognition of patterns represented by objects or radio waves. FIGS. 8 and 9 show processes associated with such recognition of generated patterns performed by Identification module, while pattern representation is performed by a temporarily connected device. Devices can be of vide variety of types using various emitters to introduce patterns into environment. As a non-limiting example, mobile devices, radio transmitters, computers, electric circuits, light emitting devices and any other can be used for such purpose. In FIG. 8 is shown process 800 for such device.

After start 802 device Loads pattern 804. Pattern can be saved in device memory or device can load it through connection with Identification module. As a next step 806 device introduces pattern into environment by displaying it and waits for action that is performed either by user or by identification module 808. Such action can be for example sending to device of a new pattern or user entering certain additional information. For example, recognition status can be inputted in device in step 810. If recognition was successful, device exits 814. If recognition was unsuccessful, the process of recognition can be checked for cancellation 812. If process is cancelled 812 then process exits 814. If process is not cancelled, it returns to step 804 where device loads either the same or different pattern.

FIG. 9 shows the process of pattern generation 900 which is performed by identification module. After start 902, module loads connected device list 904. This list corresponds to all devices that are generally connected and thus pattern generation and transmission to such is possible. In step 906 Identification module checks if there is pattern request. If there are no requests then process exits 914. If there is a pattern request, Identification module generates pattern in step 908. Pattern generation can be done by a specifically designed algorithm, that would, as a non-limiting example, use software platform's random generator to generate value from which pattern can be derived. After pattern is generated 908, Identification module updates user record 910 in data storage, so now such record would be associated with specific pattern and if such pattern is obtained by sensor and recognized, appropriate record can be retrieved. As a pre-final step Identification module sends pattern to device 912 and as a final step 914 exits. It shall be noted, that in some embodiments, Execution module's Input, output and Network sub-modules can be utilized for the purposes of data transfer between Identification module and device.

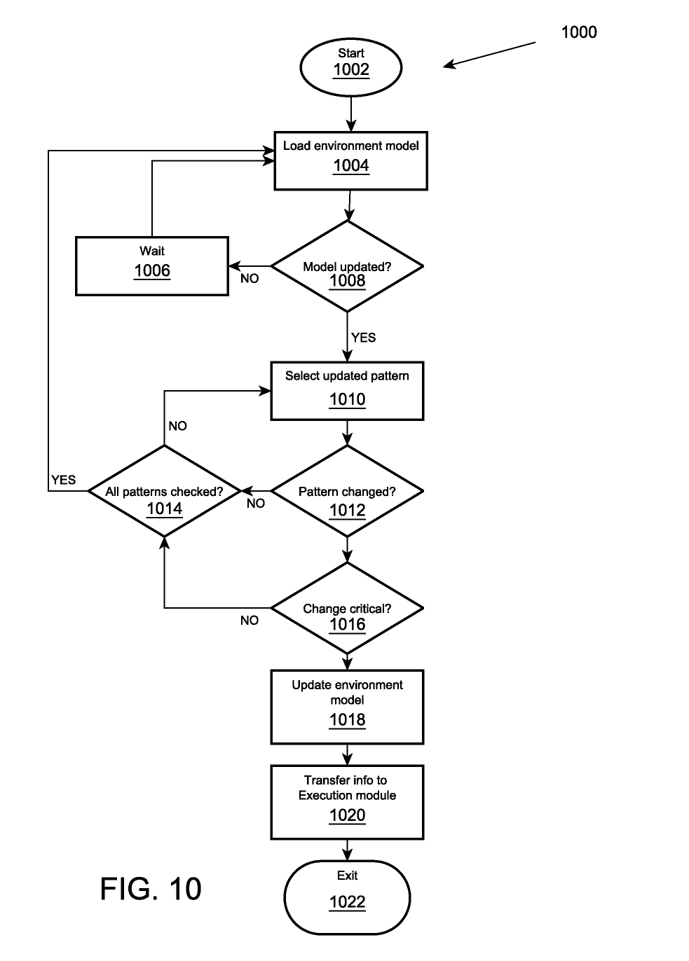

FIG. 10 shows process of tracing which is performed by Tracking sub-module of Identification Module. The goal of the process is to trace movement of payer after first identification in order to perform correct operations at every stage of movement. As a non-limiting example, while payer is standing in the queue nether payer nor payee need to be outputted the details relating to such payer, but as trade related to payer is started, such details should be outputted.

Process 1000 starts 1002 and loads the environment model 1004, which contains all the patterns recognized within certain location. Step 1008 checks if model was updated and if no changes were detected process waits 1006 and loads environment model 1004 again. If model was updated 1008 thus certain patterns have experienced change, process selects updated pattern 1010 and assesses the amount of change that has happened 1012. Change can be related to pattern attributes such as but not limited to as location, stage of processing or any other, or change can be related to pattern itself. Further process checks if change is critical 1016, which means comparison of changed parameters against per-determined values, and if change is critical 1016, then environment model is updated 1018. After that, information is transferred to execution module 1020 and process exits 1022. Alternatively, if change is not critical, other patterns can be checked from the model in step 1014 and following to 1010 or 1004.

The core advantage of the tracing sub-module is the ability to initiate various operations automatically, without any interaction with payee or payer. This provides for a more automated and non-intrusive methods of identification.

Overall, embodiments described in this section provide various ways to identify parties of trade prior to the end of trade. While third embodiment uses typical biometric and mono-pattern sensors for such purposes, second embodiment introduces means to obtain patterns non-intrusively, thus making pattern recognition process much more flexible. The flexibility of the process allows to combine it with other processes that are being performed by the parties of trade, and thus reducing time spent on servicing transactions. The preferred embodiment, creates a multi-pattern gateway, which is a universal pattern recognition system which allows to use same infrastructure for wide variety of patterns, and provides alternative means for parties of trade to be recognized. The benefits of the described embodiments will become even more apparent, after the following section, which describes Continuous transaction functionality, which can be used in combination with preferred, second and third embodiments.

### Continuous Transaction

Embodiments five and six provide functionality to completely eliminate the time spent on payment operation alone through performance continuous transaction operations. Continuous transaction functionality generally relates to Execution module and thus can be used by embodiments one, two and three by replacing process described in FIG. 4 which is foundation for such embodiments. This allows not just prior to the end of trade identification, but performance of significant part of authorization process prior to end of trade, in particular, the part of the process that requires presence of both sides of trade.

The term continuous transaction is used to specify that the process is different from a typical single transaction authorization. The core idea of those embodiments is to perform a set of authorizations continuously as trade proceeds, so by the end of trade only a partial amount needs to be authorized, thus allowing to use several methods to authorize this last part without any whatsoever involvement from parties of trade.

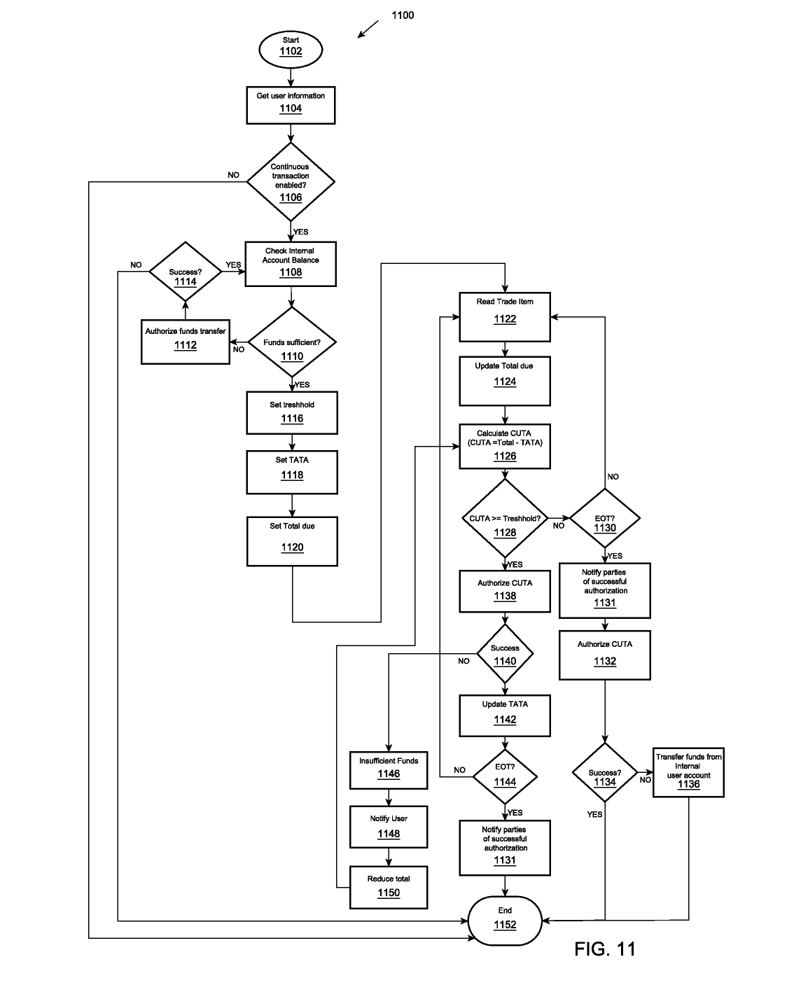

FIG. 11 shows example process of fifth embodiment. After start 1102, user information is obtained from Identification module in step 1104. Step 1106 checks if Continuous transaction is enabled and if it is not enable process exits 1152. Alternative process as shown in FIG. 4 can be used in such event.

If Continuous transaction is enabled, Continuous transaction sub-module of Execution module is activated to perform various operations. In step 1108 Internal Account balance is checked. Depending on the configuration, internal balance information can be contained within data storage of Execution module or can be available through network. Internal Account balance is funds which are dedicated as collateral. It can be represented by bank account, funds on account or for example by a pre-authorized transaction. Further the sufficiency of funds is checked in step 1110. Funds available are compared against a certain amount which was previously recorded in data storage. If funds are insufficient to perform Continuous transaction, execution module authorizes funds transfer 1112, which generally is a typical financial transaction governed by financial sub-module of Execution module. Alternatively step 1112 can be a pre-authorization transaction. If transaction fails 1114 then process exits 1152. If transaction is successful 1114, account balance check 1108 is performed again. Once finds are sufficient 1110, process sets threshold 1116. When trade is performed, a certain value that that defines the amount that one side needs to pay to another to reach settlement is defined. In the current discussion, this amount will be referred as Total. Total is a final amount of trade, as if trade was performed in a single atomic operation. Current Unauthorized Trade Amount (CUTA) is a different type of value, which defines the part of the Total, which has still to be paid to the other party in order to reach settlement. As a non-limiting example, if Total amount is 10, while 5 was already paid, CUTA is equal to Total-Paid_amount=CUTA, which for such basic example means 10−5=5. Thus, CUTA is part of Total that is still unpaid. Threshold is a value that defines how large CUTA can be accumulated between parties, before transaction authorization is being performed for this amount. Threshold generally relates to Internal Balance amount and can be smaller or larger then such amount.

After threshold is set in step 1116, Total authorized trade amount (TATA) 1118 is set. TATA represents combined amount of trade that was successfully authorized or pre-authorized. For example, If several successful authorizations were performed TATA would represent a sum of such authorizations. At the start of trade, TATA would typically be equal to zero, though it depends on the implementation thus TATA can be any amount in step 1118. As a simple non-limiting example, certain vouchers can be applied to indicate that part of the trade has been authorized prior to beginning of trade. At step 1120 Total amount is set. If no trade was performed Total would typically be equal to zero, though it depends on the implementation thus Total can be any amount in step 1120. As a non-limiting example, certain fees can be introduced at the beginning of trade, so Total amount would not be zero at start of trade.

After initial variables were set, in step 1122 trade items are read. This means inputting items of trade and their value into execution module, which can be performed by Input sub-module and various underlying scanners, readers or ports. After trade item was read, Total amount is updated in step 1124. Next, Current Unauthorized Trade Amount (CUTA) is being calculated in step 1126, using formula Total−TATA=CUTA. After CUTA was calculated, it is compared to Threshold in step 1128. If CUTA is, for example larger then Threshold, in step 1138 CUTA is being authorized or pre-authorized depending on implementation. If authorization is successful, which is determined by step 1140 and handled by financial sub-module, the Total Authorized Trade Amount is updated in step 1142. If at this point end of trade was reached, which is determined by step 1144 by monitoring various Inputs of Execution module in the following 1131 step parties are notified about successfully performed authorizations and process exits 1152. Alternatively if EOT was not reached by step 1144, the next trade item is read during step 1122 and the process continuous.

In particular case, when CUTA is being authorized in step 1138, and following step 1140 determines that authorization was unsuccessful, Insufficient funds 1146 step is initiated. In certain configurations several authorizations can be performed prior to step 1146 in order to reach certainty about insufficient funds. Step 1146 is generally handled by financial sub-module, and is followed by step 1148 which notifies users about insufficient funds, and parties can reduce Total 1150 by taking trade items off the trade list. After that CUTA is re-calculated and authorization can proceed.

In cases when step 1128 specifies that CUTA does not need to be authorized, step 1130 determines if EOD was reached. If EOD was not reached, then the trade idem reading can continue. If end of trade is reached, straight after this point parties can be notified of successful authorization 1131. At this message parties can, for example leave place of trade, or next payer can be serviced. It is highly important that this happens before the last part of CUTA is authorized. Last part of CUTA can be authorized automatically and if authorization succeeds as checked by step 1134, process exits 1152. But if authorization fails 1134, the Internal Balance amount is used to perform funds transfer in step 1136, after which process exits 1152. This is crucial part of the Continuous transaction process. As Internal Balance amount serves as collateral against failure of the authorization of the last part of CUTA, the funds are remitted to eligible party disregarding the successfulness of final authorization, thus parties assume authorization successful at earlier stage 1131. In practice this completely eliminates any time spent by parties on waiting for authorization to be performed which is one of the most significant benefits of the embodiments.

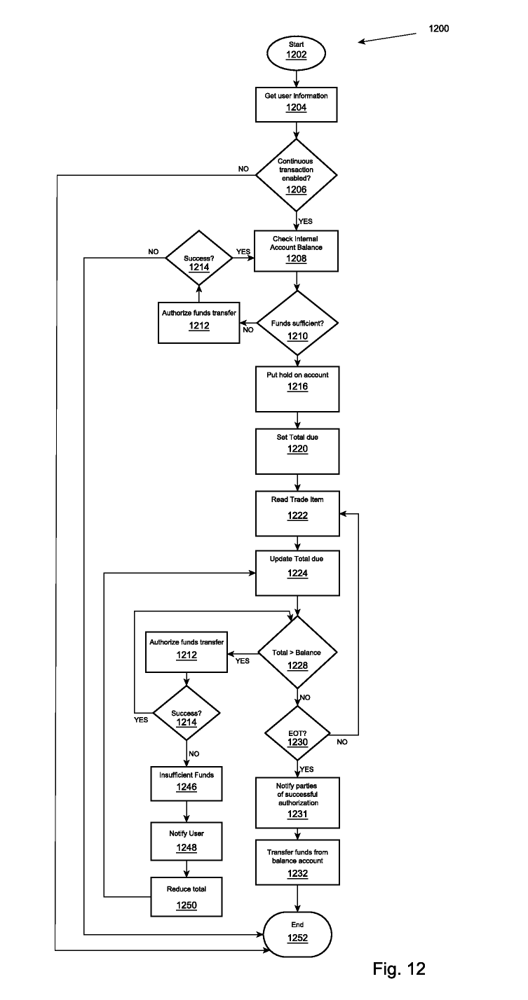

FIG. 12 shows algorithm 1200 which relates to sixth embodiment and is mostly executed by Execution module. After start 1202, user information 1204 is obtained from Identification module. Step 1206 checks if continuous transaction is enabled, and if it is enabled Internal Account Balance is checked 1208. Internal account balance represents funds that are allocated on account which is either within Execution module, or Execution module has full control over such account. Payer pre-deposits funds to such vault account and typically would deposit sum related to average ticket value. Alternatively, payer may use vault account as a typical deposit account, thus deposit sum would not be related to average ticket value.

Execution module can check amount available on the account and put hold on it 1216, suspending all other operations with such account, for the duration of operation described by algorithm 1200. Before putting hold on account 1216, algorithm 1200 checks if funds are sufficient 1210. In case the amount of trade is larger than the funds available on vault account, an additional standard sum is authorized 1212, with vault account being the destination for funds. Such transfer or authorization results 1214 either in continuation or exit 1252. Funds transfers for algorithm 1200 are performed as transaction internal to Execution module or through interbank electronic funds transfer (EFT) networks.

After putting hold on account 1216, at step 1220 Total amount is set. If no trade was performed Total would typically be equal to zero, though it depends on the implementation thus Total can be any amount in step 1120. As a non-limiting example, certain fees can be introduced at the beginning of trade, so Total amount would not be zero at start of trade.

After initial variables were set, in step 1222 trade items are read. This means inputting items of trade and their value into execution module, which can be performed by Input sub-module and various underlying scanners, readers or ports. After trade item was read, Total amount is updated in step 1224. After that in step 1228, Total is compared with amount available on Internal Balance account, and if amount is insufficient, funds are authorized for transfer from another account or basket of accounts in step 1212. In case of failure of such authorization Insufficient funds 1246 step is handled by financial sub module, resulting in 1248 notification of users. After that Total can be reduced in step 1250 by removing trade items from trade.

If step 1228 results in Total amount being less then Balance, step 1230 checks if end of trade was reached. If end of trade was not reached, algorithm 1200 proceeds to reading more trade items 1222. If EOT was reached parties are notified about successful authorization 1231 and funds transfer is performed in following 1232. As funds on the vault account serve as collateral, the parties of trade do not need to wait till the end of authorization. After that algorithm exits 1252. Generally, algorithm 1200 allows determine what amount of trade is allowed by the amount of funds available prior to the end of trade. This means that transaction authorization procedure is performed before end of trade, which allows to reduce overall time spent on servicing customer's payment.

Overall, fifth and sixth embodiments allow to perform transactions continuously, without introduction of any new risks as balance or vault accounts serve as collateral. From the description above it is clear that there can be many other ramifications of such processes, while the main principle of elimination of the need of parties to wait after the EOT is being met.

### Operational Description

FIG. 2 shows various processes of performance of trade and payment related operations and compares them in terms of total duration. It describes various methods of electronic payments. Elapse of time 1302 represents a horizontal axis over which processes are compared. Vertical axis represents various process types that can be performed. Within each process, vertical axis represents parallelizing of payment related operations in respect to trade process. It shall be noted, that payment related operations can and shall be parallelized in respect to each other in various implementations.

At the core of all processes is trade process 1306, which represents trade related operations, such as but not limited to, trading with another payer, reading product barcodes, performing packing or unpacking, testing, forming palette, making contractual agreements, performing service or any other activity. Trade process 1306 shall also include time in respect to payer during and prior to shopping, coming to the POS, waiting in queue or during performance of any other operation in the area reachable by means of sampling. Thus, trade process is any time prior to end of trade.

Standard process 1, shown by element 1304 is a typical payment process performed through use of any tokens. As a non-limiting example, tokens can be magnetic stripe, chip, RF or other cards, as well as tokens of various different shapes. Tokens are currently used only after end of trade operations. The only exception to this use case is pre-authorization that can be performed through certain tokens, but such operation is just a different form of authorization, when money is not withdrawn within short time but reserved, otherwise process is identical to standard authorizations. Thus, this method is discussed as part of Standard Process 1.

For most of tokens process of payment starts with taking token out 1308. Then transaction authorization is performed 1310. Transaction authorization is performed by reading token and then sending information from such token combined with trade amount to authorization server. Then user authorization step 1312 is performed and after that token is concealed 1314. It shall be noted, that for some implementations such as magnetic stripe cards the transaction authorization 1310 happens prior to user authorization 1312, in which case the later constitutes signing the receipt. In other implementations, User Authorization 1312 happens prior to Transaction Authorization 1310, such as for example for smart cards, where User Authorization 1312 constitutes using tokenless method for user authorization, such as biometrics or code entry. Respective time spent on performance of such method of servicing transaction is shown by Duration Standard 1, element 1366.

Standard process 2, which is represented by element 1320 shows a process of tokenless identification. Generally, this is represents tokenless biometric payment system as other tokenless pattern recognition payment systems are not common. At the end of trade process user identification is performed 1324 which means recognition of various biocharacteristics of users. Such process can take significant time, depending on the type of biometric sample that is being identified. Next, user authorization 1312 happens, generally through input of various codes. Transaction authorization 1310 is performed after user authorization. Through Standard process 2 have potential to provide for faster than Standard process 1 payment procedure as some prior art teaches, in reality such process is just marginally faster, and in some cases such as if, for example 3D facial image is used as pattern or several patterns, such as fingerprints from several fingers are being recognized, can potentially take longer than the standard process. Respective time spent on performance of such method of servicing transaction is shown by element 1365, Duration Standard 2.

Process type A 1330 represents forth embodiment. Steps 1308 taking out token and 1314 concealing token are performed during trade process, while token information is buffered by Execution module. After trade process is finished Transaction Authorization 1310 and User authorization 1312 either in this or opposite order. Process type A significantly reduces time spent on payment operation without any change to tokens or networks that handle the transaction authorization. Respective time spent on performance of such method of servicing transaction is shown by element 1364, Duration Type A.

Process type B 1340 represents preferred, second and third embodiments, in particular configuration when Execution module performs operations in a standard way, authorizing transaction 1310 after end of trade. User Identification 1324 and user authorization 1312 happen before end of trade process 1306. In some implementations user authorization step 1312 can be omitted. Such configuration results in significant reduction of time spent by parties on servicing payment. Respective time spent on performance of such method of servicing transaction is shown by element 1363, Duration Type B.

Process type C 1350 shows preferred, second and third embodiments, wherein Execution module functions according to fifth and sixth embodiments, thus Continuous transaction operation is performed. Such process allows to perform User Identification 1324, User authorization 1312, and Transaction Authorization 1310 during process of trade. In some implementations user authorization step 1312 can be omitted. This process completely eliminates time spent by parties on servicing payment operations. Respective time spent on performance of such method of servicing transaction is shown by element 1362, Duration Type C. As time spent on servicing payment is eliminated completely, and generally is not affected by variations in time spent on User Identification 1324, especially in preferred and second embodiments and as User authorization 1312 can be omitted, such process 1350 is the fastest possible way to perform payment operation.

### Conclusion

While the above description contains many specificities, these should not be construed as limitation on the scope of any embodiment, but as exemplifications of the presently preferred embodiments thereof.

It is envisioned that principles mentioned above can have many other embodiments. In alternative embodiments, system is not directed towards financial operations but is a tool for access control. Architecture of Execution module provides for such functionality. Yet in alternative embodiments, system can be used for merchant recognition and peer to peer funds transfers. Yet also embodiments system may include methods to initiate emergency call or notify authorities of fraud.

Overall, system and a method of parallelizing payment operations for the purpose of reduction of time spent on payment processing by parties of trade has been illustrated. It will be appreciated by those skilled in the art that the system and method can be used to perform all types of financial transactions, and can be built using various types of sensors and configurations. It should be appreciated that in the development of any such actual implementation, as in any engineering or design project numerous implementation-specific decisions must be made to achieve the developer's specific goals, such as compliance with system-related and business-related constraints, which may vary from one implementation to another. It will thus be appreciated by those skilled in the art that other variations of the present invention will be possible without departing from the scope of the invention as disclosed.

The scope of the invention should be determined by the appended claims and their legal equivalents and not by the examples given.

1. A method of customer identification prior to the end of trade, which substantially reduces time spent by payee on checkout of said customer, comprising
a. obtainment of customer identification pattern;
b. retrieval of customer information based on said pattern;
whereby said identification is performed while payee does one or plurality of other operations.

2. The method of claim 1 further comprises:
c. performance of financial transaction, based on said information;

3. The method of clam 1, wherein other operation is reading barcodes;

4. The method of claim 1, wherein other operation is trading with at least one other customer;

5. The method of claim 1, wherein other operation is selected from the group consisting of: packaging, formation of palette, performance of service, performance of testing, making of contractual agreements, performing unpacking.

6. The method of claim 2, wherein financial transaction is performed when amount of trade reaches a pre-determined threshold;

7. The method of claim 1, wherein payee is non-human, selected from the group consisting of: kiosk, ATM, automated checkout terminal or other non-human equipment;

8. A Method for performing financial transaction, which substantially reduces time spent by payee and customer on checkout, wherein transaction is performed when pre-determined threshold is reached;

9. The method of claim 8, wherein amount of trade reaches a pre-determined threshold;

10. The method of claim 9, wherein transaction is performed at Point of Sale;

11. The method of claim 8 wherein one or plurality of thresholds are used;

12. The method of claim 8, wherein threshold is defined by collateral pre-deposited by customer;

13. The method of claim 8, wherein transaction constitutes drawing funds to plurality of accounts;

14. The method of claim 8, wherein transaction constitutes drawing funds to one or plurality of accounts whereby said accounts are dedicated for collateral;

15. The method of claim 8, wherein if funds on at least one account are not sufficient, funds are drawn from at least one other account;

16. The method of claim 8, wherein said customer is identified by automatic or partially automatic recognition of pattern;

17. The method of claim 8, wherein customer is identified by reading information from token;

18. The method of claim 8, wherein said threshold is defined by a group of time of data input, location of data input, time since last data input, time since last transaction has been performed, number of changes of amount of trade.

19. A system for performing financial operations, which substantially reduces time spent by payee and customer on checkout, comprising:
a. means of identification, which are used for obtainment of identification pattern and comparing the pattern against stored data, wherein pattern can be a biometric type or non human type;
b. means of execution, which are used for performance of financial operation associated with customer record through the identification module;
whereby identification is performed prior to the end of trade.

20. The method of claim 19, wherein identification means perform identification while said customer does other operation, selected from the group consisting of: scanning barcodes, bagging, weighting, taking out token, whereby said system is part of or connected to Automated Checkout Machine.
